(19) United States
(12) Patent Application Publication
(10) Pub. No.: US 2006/0018294 A1
(43) Pub. Date: Jan. 26, 2006

(54) Internet high speed packet access

(76) Inventors: Ari Kynaslahti, Helsinki (FI); Juha T. Heikkila, Espoo (FI); Hannu Hakkinen, Espoo (FI); Harri Holma, Helsinki (FI); Sami Uskela, Helsinki (FI); Pertti Paski, Tampere (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 11/168,574

(22) Filed: Jun. 29, 2005

Related U.S. Application Data
(60) Provisional application No. 60/583,349, filed on Jun. 29, 2004.

(51) Int. Cl. H04Q 7/24

(52) U.S. Cl. 370/338

(57) ABSTRACT

A system for connecting a high-speed packet access (HSPA) user equipment to an Internet node. The system includes a HSPA user equipment, a base station node for receiving signals from the HSPA user equipment and an adapter, integrated in the base station node, wherein the adapter enables the HSPA user equipment to communicate to an Internet node.

### REFERENCE TO RELATED APPLICATIONS

This application claims benefit under 35 U.S.C §119(e) of provisional application No. 60/583,349, filed on Jun. 29, 2004 the contents of which are hereby incorporated by reference.

### BACKGROUND OF THE INVENTION

1. Field of Technology

This invention is directed to applying High Speed Packet Access to an internet environment.

2. Description of the Related Art

In the current specifications of the third generation mobile networks (referred to as UMTS, Universal Mobile Telecommunication System), the system utilizes the same well-known architecture that has been used by all main second generation systems. A block diagram of the system architecture of the current UMTS network is presented in FIG. 1. The UMTS network architecture includes the core network (CN), the UMTS terrestrial radio access network (UTRAN), and the user equipment (UE). The core network is further connected to the external networks, i.e. the Internet, PSTN (Public Switched Telephone Network) and/or ISDN (Integrated Digital Services Network).

The UTRAN architecture consists of several radio network subsystems (RNS). The RNS is further divided into the radio network controller (RNC) and several base stations (BTS, referred to as Node B in the 3GPP specifications). In this architecture there are several different connections between the network elements. The Iu interface connects CN to UTRAN. The lur interface enables the exchange of signaling information and user plane information between two RNCs. There is no equivalent interface to lur in the architectures of the second generation mobile networks. The radio network layer (RNL) signaling protocol across the Iur interface is called the radio network subsystem application part (RNSAP). The RNSAP is terminated at both ends of the lur interface by an RNC. The Iub interface connects an RNC and a Node B. The Iub interface allows the RNC to indicate the required radio resources to the Node, for example, to add and delete cells controlled by Node B to support communication of dedicated connection between UE and C-RNC(Control RNC), information used to control the broadcast and paging channels, and information to be transported on the broadcast and paging channels. One Node B can serve one or multiple cells. UE is connected to Node B through the Uu radio interface. UE further consists of a subscriber identity module (USIM) and mobile equipment (ME). They are connected by the Cu interface. Connections to external networks are made through Gateway MSC (Mobile Services Switching centre) (towards circuit switched networks) or GGSN [Gateway GPRS (Group Packet Radio System) Support Node] (towards packet switched networks).

The general protocol model for UTRAN Interfaces is depicted in FIG. 2, and described in detail in the following. The structure described is based on the principle that the layers and planes are logically independent of each other.

The Protocol Structure consists of two main layers, Radio Network Layer and Transport Network Layer (TNL). These are presented in the horizontal planes of FIG. 2. All UTRAN related issues are visible only in the Radio Network Layer, and the Transport Network Layer represents the standard transport technology that is selected to be used for UTRAN. UTRAN has certain specific requirements for TNL. For instance, the real time requirement, i.e. the transmission delay has to be controlled and kept small.

In WCDMA based systems high speed data transmission may be enabled, e.g., by means of the so called high speed downlink packet access (HSDPA) technology. The high speed downlink packet access (HSDPA) may include functions such as fast hybrid automatic repeat request (HARQ), adaptive coding and modulation (AMC) and/or fast cell selection (FCS). These functions are known by the skilled person and will thus not be explained in more detail. A more detailed description of these and other function of the HSPDA can be found, e.g., from a third generation partnership project technical report No. 3G TR25.848 release 2000 titled ‘Physical Layer Aspects of UTRA High Speed Downlink Packet Access’.

HSPA (high speed packet access) includes high speed downlink packet access (HSDPA) and/or high speed uplink packet access (HSUPA). In HSPA each user equipment receiving data on a high speed downlink shared channel (HS-DSCH) also has an associated dedicated channel (DCH) allocated. The dedicated channel may be mapped to a dedicated physical channel (DPCH) in the physical layer. The DPCH is typically divided into dedicated physical data channel (DPDCH) and dedicated physical control channel (DPCCH) both in the uplink and the downlink. Data such as the power control commands, transport format information, and dedicated pilot symbols are transmitted on the DPCCH. Information such as diversity feedback information may also be transmitted on DPCCH in the uplink. The HS-DSCH may be mapped to one or several high speed physical downlink shared channels (HS-PDSCH) in the physical layer.

The associated dedicated channel is typically provided both in the downlink and the uplink. The dedicated channel is typically used to carry HSDPA related information/signaling as well as other dedicated data such as speech and control data. The user equipment may communicate with several base stations at the same time. For example, the associated dedicated channel may be in soft handover.

### SUMMARY OF THE INVENTION

An embodiment of the present invention is a system for connecting a high speed packet access (HSPA) user equipment to an Internet node. The system includes a HSPA user equipment, a base station node for receiving signals from the HSPA user equipment and an adapter, integrated in the base station node, wherein the adapter enables the HSPA user equipment to communicate to an Internet node.

Another embodiment of the present invention is a method of enabling a high speed packet access (HSPA) user equipment to communicate with an Internet node. The method includes providing a HSPA user equipment that communicates to an wireless system, integrating an adapter and connecting the HSPA user equipment to the Internet node via the adapter.

Another embodiment of the present invention is an adapter for enabling a high speed packet access (HSPA) user equipment to communicate with an Internet node. The adapter includes a protocol stack, wherein the protocol stack includes an Internet Protocol/Mobile IP (IP/MIP) protocol.

### BRIEF DESCRIPTION OF THE FIGURES

FIG. 1 is block diagram of the system architecture of the current UMTS network;

FIG. 2 illustrates the general protocol model for UTRAN Interfaces;

FIG. 3 illustrates a system according to an exemplary embodiment of the invention;

FIG. 4 illustrates an alternate embodiment to the system illustrated in FIG. 3;

FIG. 5 illustrates another embodiment of the HSPA system;

FIG. 6 illustrates an embodiment of the system illustrated in FIG. 5, for networking to neighboring systems;

FIG. 7 illustrates an embodiment of the system illustrated in FIG. 5, for networking to neighboring systems; and

FIGS. 8 and 9 illustrate an exemplary system for authentication and billing according to an embodiment of the invention..

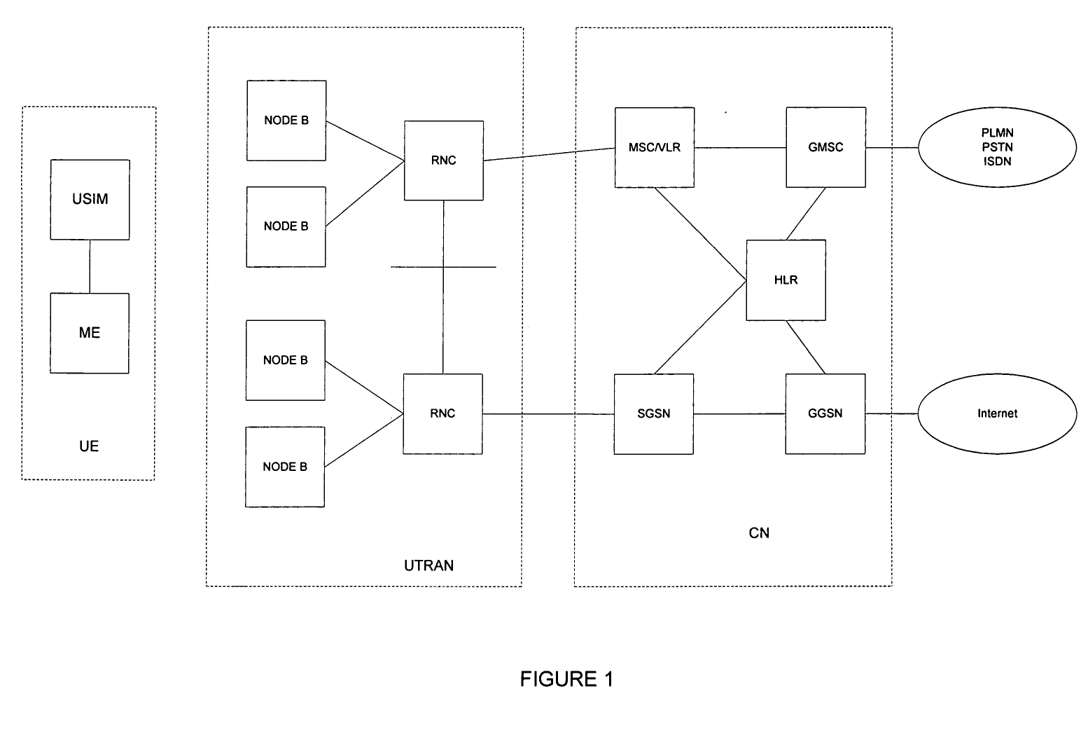

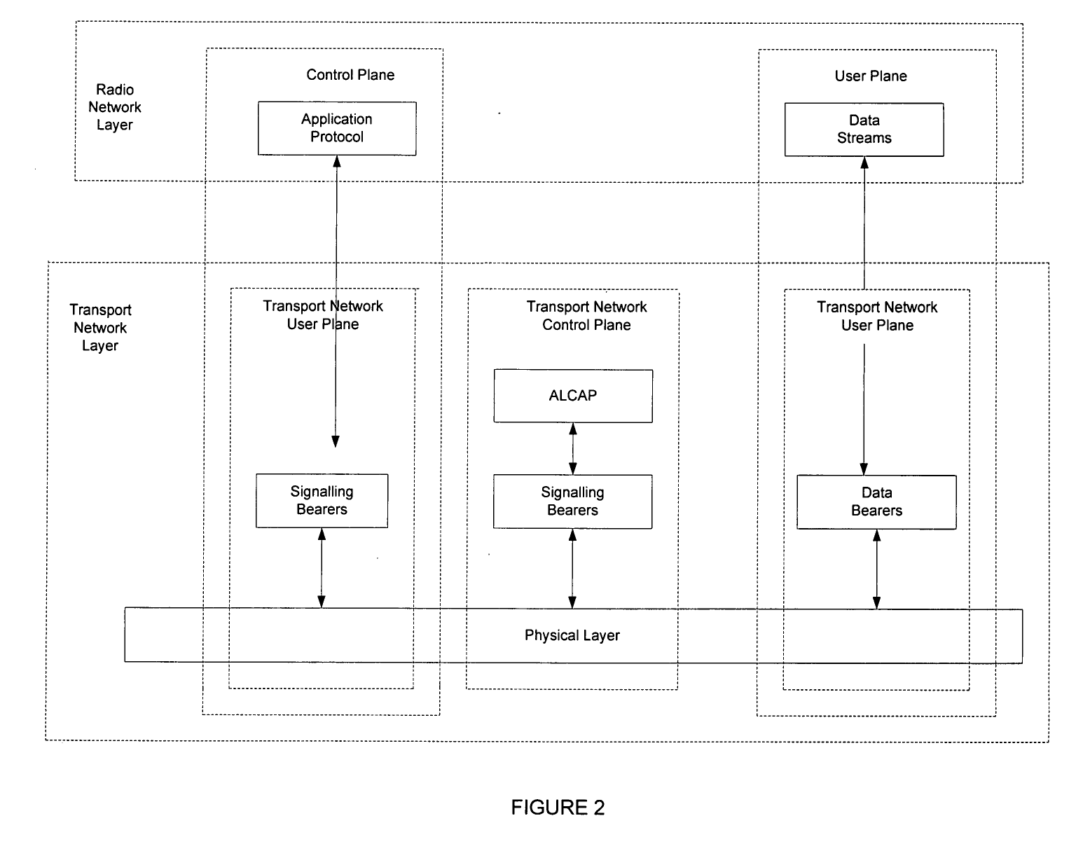

### DETAILED DESCRIPTION OF THE PREFERRED EMBODIMENT(S)

The present invention, in one embodiment, is directed to applying HSPA to internet environments. Internet HSDPA will utilize the Internet, via conventional Internet nodes, and enable 3GPP HSDPA/HSUPA user equipment to communicate to an internet node through appropriate conversion equipment. For example, embodiments of the invention includes support for voice over internet protocol (VoIP), and is compatible with HSDPA and HSUPA carriers above L1. Mobility support for the user equipment can be provided at speeds up to 250 km/h.

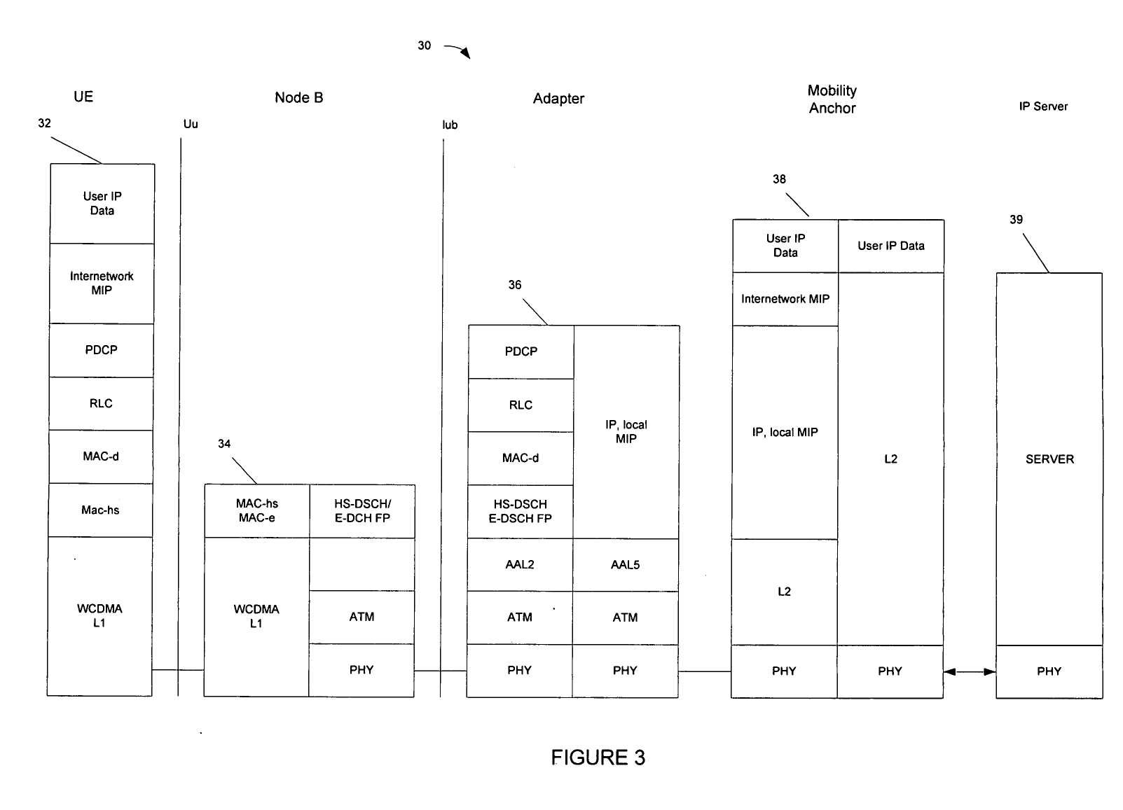

FIG. 3 illustrates an exemplary embodiment of an HSPA Internet system according to present invention. FIG. 3 illustrates the protocol stacks of the user place (U-plane), for a user equipment UE 32, Node B 34, HSPA adapter 36 and Mobility Anchor 38, included in the HSPA Internet system 30. The user equipment (UE) 32 is 3GPP and HSPA compatible. The protocol layers for the UE comprises the following layers: User IP data, Internetworking medium interface protocol (MIP) layer, the Packet Data Convergence Protocol, radio link control (RLC), medium access control (MAC) entities, and the WCDMA entities.

The UE 32 and the Node B or base station 34 are connected via the Uu air interface. The U-plane protocol stack for Node B 34 includes the layers MAC-hs and MAC-e, HS-DSCH/, asynchronous transfer mode (ATM) layer, and physical layer (PHY).

[PLEASE CAREFULLY REVIEW THE FOLLOWING PARAGRAPH FOR ACCURACY AND COMPLETENESS] The HSPA system according to the exemplary embodiment further includes an HSPA adapter 36. The adapter 36 contains the necessary protocol stack which enables the HSPA enabled UE to communicate to an Internet node. The adapter 36 is connected to the Node B PHY layer via the Iub interface. In another embodiment the adapter is into a base transceiver station (BTS). The protocol layers of the U-plane stack for the HSPA adapter 36 include PDCP, RLC, MAC-d, HS-DSCH/E-DSCH frame protocol, ATM adaptation layer 2 (AAL2) and AAL5. The layers of the adapter further include ATM layers and PHY layers. The HSPA adapter 36 further includes an IP/Mobile IP (IP/MIP) layer. The IP/MIP layer enables connection to Internet nodes and enables system mobility.

According to this exemplary embodiment of the invention, the HSPA Internet system further includes a Mobility Anchor 38. The Mobility Anchor 38 is connected to the HSPA adapter 36 via their respective PHY layers. The protocol layers of the Mobility Anchor 38 include User IP data, Internetwork MIP, and L2 layer. The Mobility Anchor 38 further includes an IP local MIP protocol layer. The IP local MIP protocol layer facilitates system mobility.

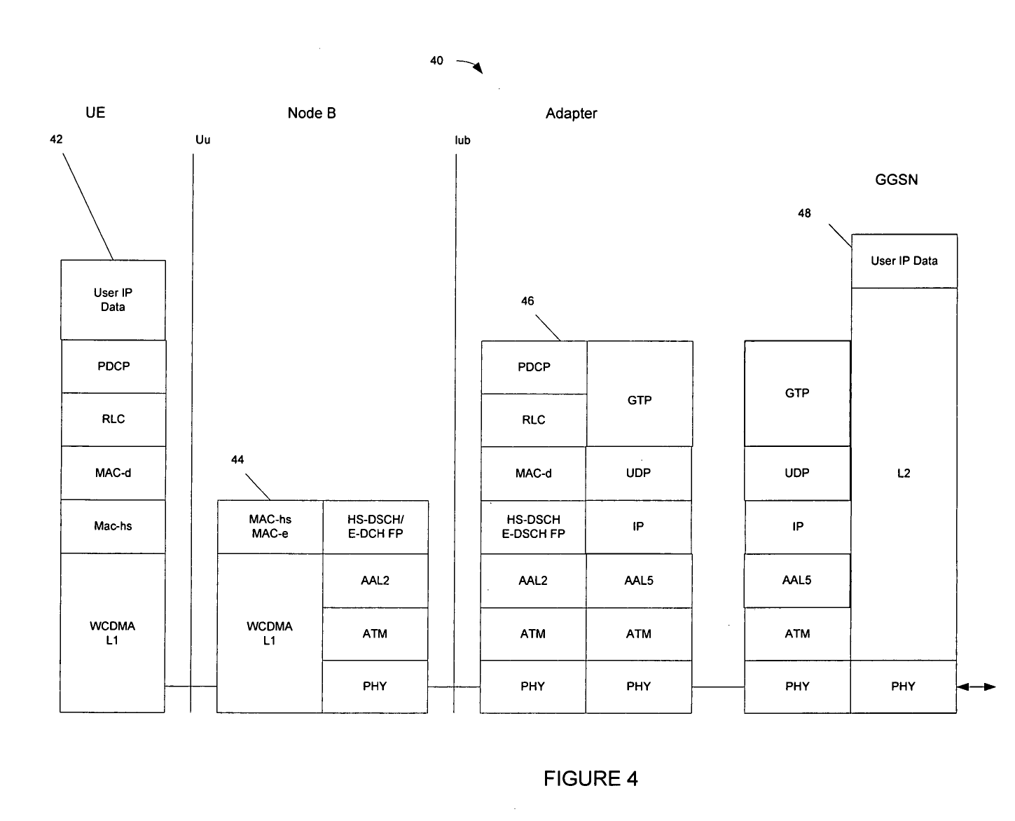

FIG. 4 illustrates another exemplary embodiment of the system illustrated in FIG. 3. The protocol stacks of the UE 42, and Node B 44 are the same as described in FIG. 3. However, the HSPA adapter 46 according to the present embodiment, includes a general packet radio service (GPRS) tunneling protocol (GTP), a user datagram protocol (UDP) and a IP, instead of the IP local MNP layer shown in FIG. 3. Further, the HSPA system according to the present embodiment further includes an Gateway GPRS support node (GGSN) that is connected to the HSPA adapter 48 through the PHY layers of each device. In alternate embodiments the HSPA adapter is connected to the GGSN via an ATM switch and site switch (not shown).

The GGSN protocol layers include PHY, ATM, AAL5, IP, UDP AND GTP layers discussed above. In addition, an L2 protocol is horizontal to the ATM, AAL5, IP, UDP AND GTP layers. Because the HSPA adapter 46 is provided in this system, the user IP data is able to be communicated from the UE 42 to the GGSN 48.

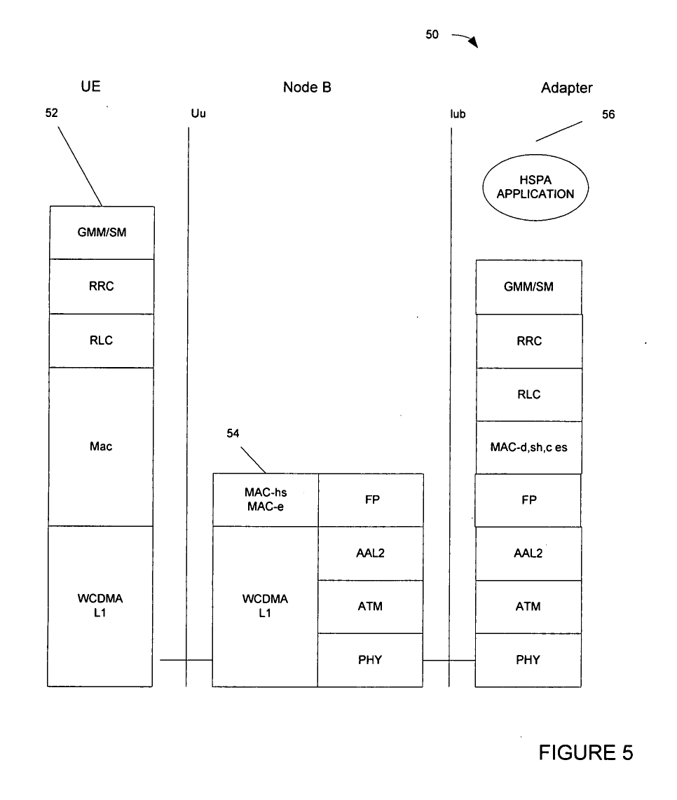

In another exemplary embodiment of the present invention, the HSPA system is implemented in the control plane (C-Plane). FIG. 5 illustrates the HSPA Internet system implemented in the C-Plane. The system according to this embodiment, includes an UE 52, Node B or base station 54 and an HSPA adapter 56. The control plane controls the UE 52 over the air interface to control the air interface and terminals.

In the HSPA system according to the present exemplary embodiment, the UE 52 protocol layers include a GPRS mobility management/session management layer (GMMISM). The GMM sub-layer supports user mobility, registration and management of mobility data. This sub-layer also checks the identity of the subscriber terminal and the identities of allowed services. The session management sub-layer SM manages all functions related to the management of a packet-switched call but it does not detect user mobility. The session management sub-layer SM establishes, maintains and releases connections.

The protocol layers of the UE 52 further includes a Radio Link Control (RLC) layer, that communicates through a logic channel (not shown) with the MAC layer. The Radio Resource Control (RRC) layer, is used to provide control signals to and from the various underlying layers. The MAC layer and the WCDM layer are the same as described above.

Node B 54, which is connected to the WCDMA layer of UE 52 via the Uu interface, further includes the PHY, ATM, and AAL2 and a frame protocol (FP). In alternative embodiments, the FP includes a combination of FP-paging channel (FP-PCH), FP-random access channel (FP-RACH), FP-forward access channel (FP-FACH) and FP-dedicated channel (FA-DCH). The PHY of Node B is connected, via the Iub interface, to the PHY of the HSPA adapter 56.

The C-plane protocol stacks of the HSPA adapter 56 includes the ATM, AAL2, FP, MAC, RLC, RRC AND GMM/SM layers as discussed above. The HSPA adapter further includes an HSPA application protocol.

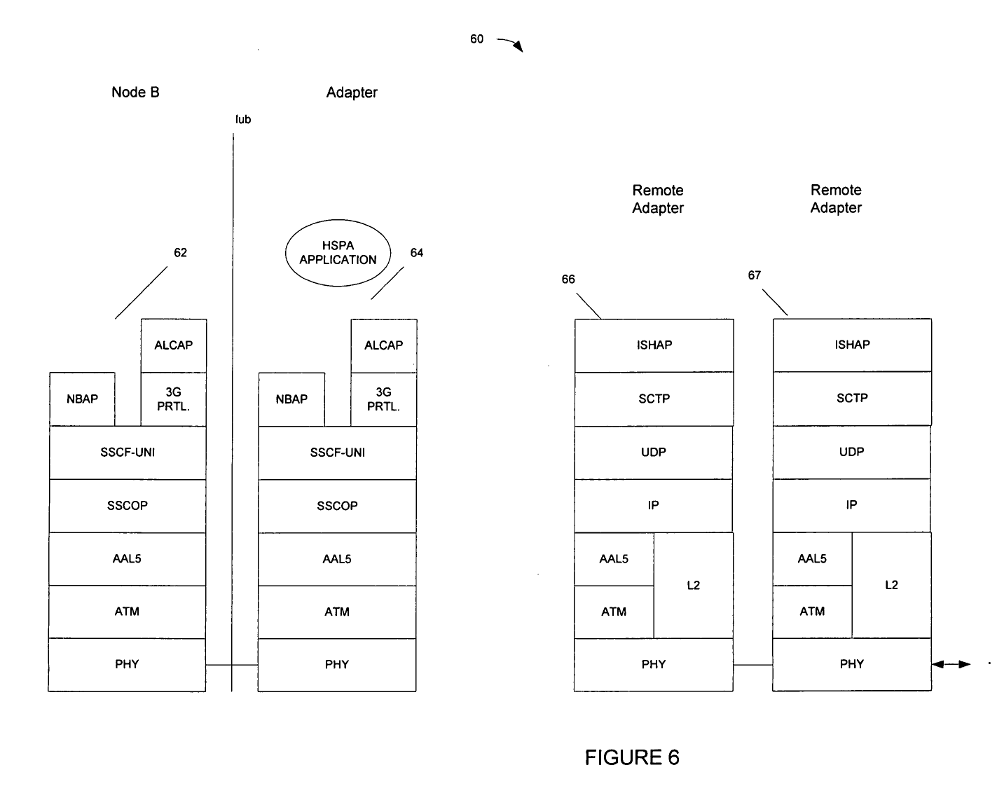

FIG. 6 illustrates still another exemplary embodiment of the present invention. The embodiment illustrated in FIG. 6 is a HSPA system implemented in the C-plane, that enables networking to neighboring systems. The networking of neighboring or remote systems is enabled by including at least one remote adapter that is integrated with an associated remote base station.

Node B 62 protocol stacks include and PHY, ATM, and ATM adaptation layer 5 (AAL5). The protocol stack of Node B 62 further includes an service specific connection oriented protocol (SSCOP), a service specific coordination function—user network interface (SSCF-UNI), a Node B application part (NBAP), a 3G protocol such as Q2150.2. The top layer is an access link control application protocol (ALCAP). Node B is connected, via the lub interface directly to the physical layer of the HSPA adapter 62 or through an ATM switch. The HSPA adapter 64 protocol stack includes all of the protocol stacks identified above for Node B 62. In addition, the HSPA adapter further includes an HSPA application protocol.

According to this exemplary embodiment, the HSPA adapter 64 enables communication with the remote adapters 66 and 67.

The protocol layers for the remote adapters include PHY layer, through which another remote adapter is connected. The protocols above the PHY are the ATM, L2 and AAL5 layers. Further provided above the ATM, L2 AND AAL5 is the IP protocol. The stream control transmission protocol (SCTP) is above the IP. A subset of the I-HSPA Application Protocol (ISHAP) protocol is above the SCTP. ISHAP enhances inter I-HSPA (BTS and adapter) mobility, by including all of the signaling needed to prepare a I-HSPA BTS for handover. This includes, but is not limited to, UE L1 preparation and context transfer. As shown in FIG. 5, other remote adapters are connected via the PHY layer.

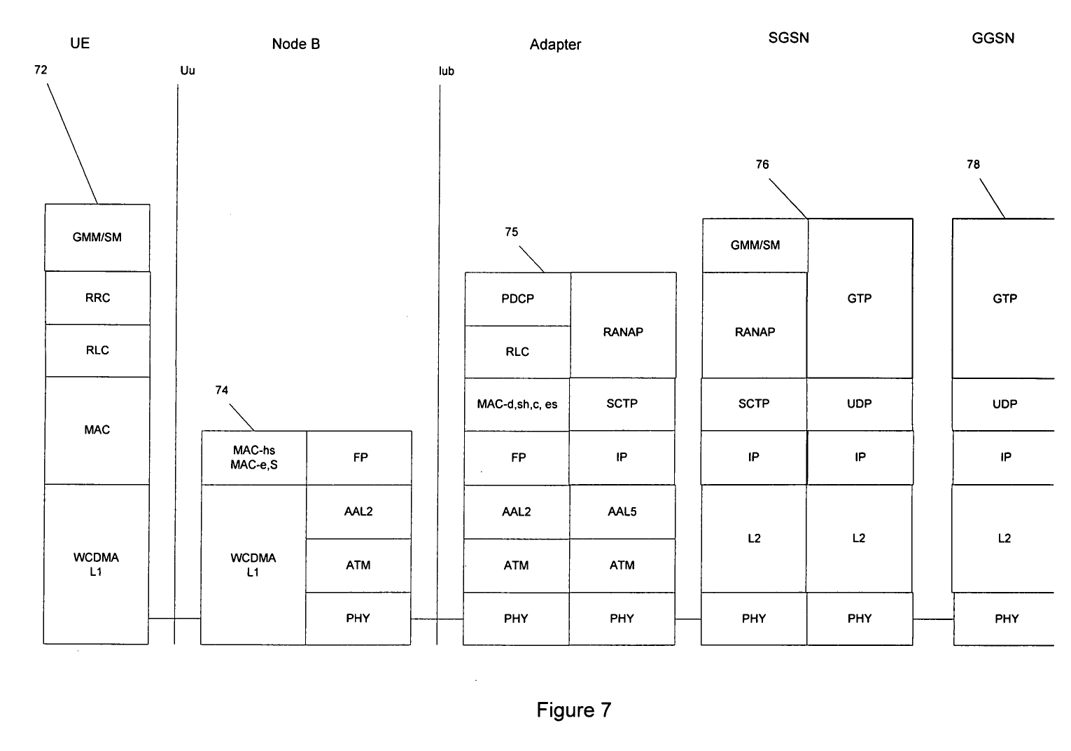

FIG. 7 illustrates an alternate embodiment to the embodiment illustrated in FIG. 5. According to this exemplary embodiment, the system is implemented on the C-Plane. The system includes UE 72, Node B 74, HSPA adapter 75, a serving GPRS support node (SGSN) 76 and a GGSN 78. The UE 72 protocol stack includes WCDMA L1, a MAC above the WCDMA, an RLC above the MAC, an RRC above the RLC, and a GMM/SM protocol above the RRC. The UE 72 is connected to Node B 74 through the Uu interface, by their respective WCDMA layers.

Node B 74 includes the WCDMA, PHY, ATM, AAL2, MAC and FP protocols discussed above. In alternative embodiments, the FP includes a combination of FP-paging channel (FP-PCH), FP-random access channel (FP-RACH), FP-forward access channel (FP-FACH) and FP-dedicated channel (FA-DCH).

The HSPA adapter 75 is connected to the Node B 74 via the lub interface, through the PHY layer. However, Node B 74 and the HSPA adapter 75 can be connected by an ATM switch (not shown) integrated with the Node B 74. The HSPA adapter according to the embodiment illustrated in FIG. 7, includes the PHY and ATM protocols as discussed above. The HSPA adapter further includes AAL2 and AAL5 above the ATM, the FP and IP above the AAL2 AND AAL5 respectively. The MAC and SCTP above the FP and IP respectively. An RLC is above the MAC layer and a RRC is above the RLC layer. The HSPA adapter further includes a Radio Access Network Application Part (RANAP) layer. The RANAP enables an I-HSPA to communicate standards based SGSN. Thus, full SGSN functionality with I-HSPA is enabled.

As stated above, the HSPA system according to the present embodiment further includes an SGSN 76. The SGSN 76 is directly connected to the HSPA adapter 75 through their respective PHY layers. In an alternate embodiment, the HSPA adapter is connected to the SGSN via an ATM switch (not shown). The SGSN includes L2 above the PHY layers, and IP above the L2 layers. SGSN further includes both the SCTP and UDP above the IP layers. The RANAP layer is above the SCTP layer and a GMM/SM layer above the RANAP layer. The SGSN further includes a GTP above the UDP layer.

The system according to the present embodiment further includes a GGSN 78 connected to the SGSN 76 via their respective PHY layers. The GGSN includes an L2 layer above the PHY. An IP layer is further provided above the IP. The GGSN, according to the present embodiment further includes a UDP above the IP and a GTP above the UDP.

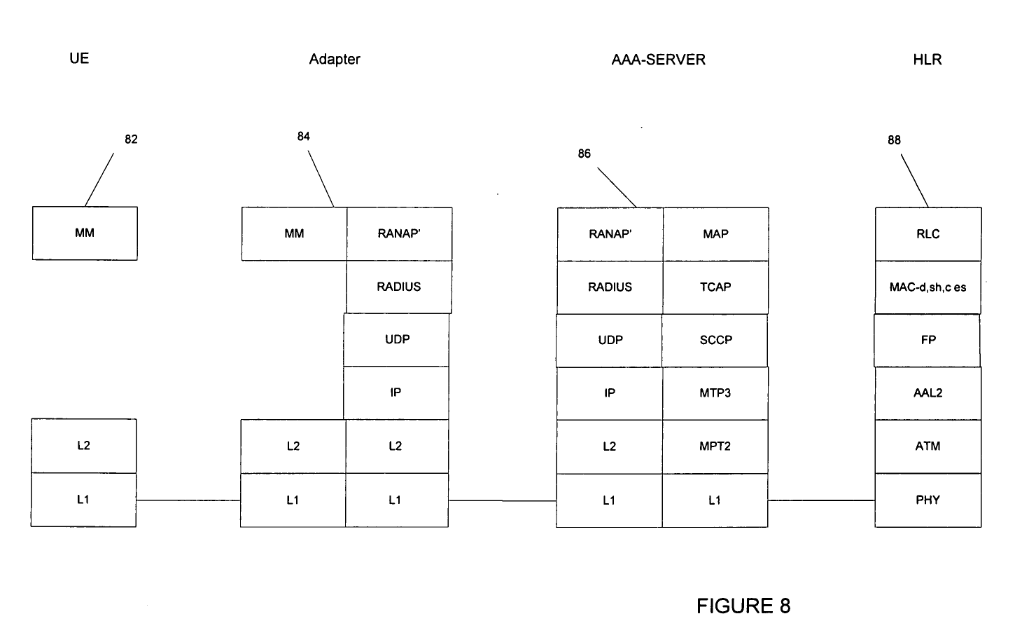

FIG. 8 illustrates another exemplary embodiment of the HSPA Internet system. According to this embodiment, HSPA UE authentication is provided. Authentication is the process of determining whether an entity is who it purports to be. Further, in the HSPA Internet system, authorization may be provided which provides the UE permission to do or have something. According to this embodiment, authentication/authorization is provided by connecting the UE 82 and AAA server 86 to the HSPA adapter 84. The protocol stacks of the UE 82 according to this embodiment includes L1 and L2 layers and mobility management (MM).

FIG. 8 shows the protocol stack for the HSPA adapter 84 according to the present embodiment. The protocol stack includes L1 and L2 layers, IP above the L2 layer and UDP layer above the IP, and Radius above the UDP protocol. At least a portion of the RANAP (RANAP′) is above the Radius layer. According to the present embodiment, in the HSPA adapter 84, MM messages are mapped to RANAP′ messages or are carried transparently over RANAP′. The HSPA adapter 84 is connected to the AAA server 86, via their respective L1.

The AAA server 86 includes the L1, L2, IP, UDP, Radius and RANAP′ protocol stacks. An AAA server program handles user requests for access to computer resources and provides authentication, authorization and accounting services.

In the HSPA system illustrated in FIG. 8, a Home Locator Register (HLR), is included. The protocol stacks for the HLR include L1, message transport (MTP) 2, MTP 3, SCCP, transaction capabilities application part (TCAP) and a mobile application part (MAP).

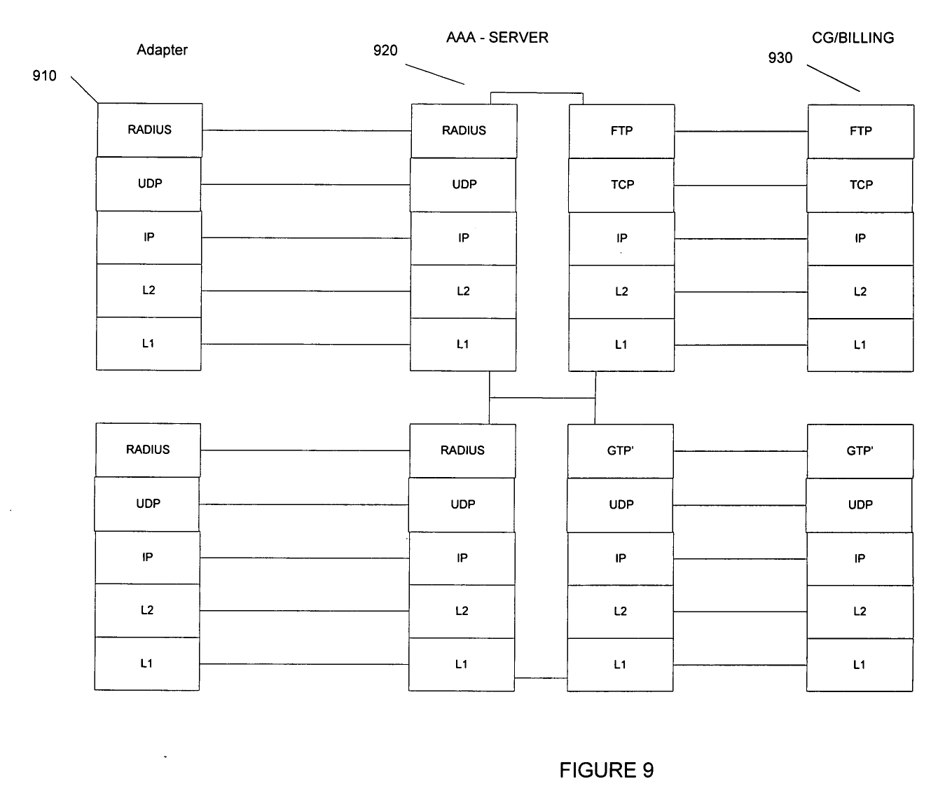

FIG. 9 illustrates the Accounting portion of the present embodiment of the invention. According to this embodiment, the HSPA system enables accounting and off-line charging for the host system. This is accomplished, for example, measuring the resources the user consumes during access, including but not limited to, the amount of data a user has sent and/or received. According to the present embodiment, an HSPA adapter 92 is integrated into a BTS site. The protocol layers of the HSPA adapter are connected to an Authentication Authorization and Accounting (AAA) server 94.

The protocol layers shown in FIG. 9 that have not been discussed above will discussed below. The Radius layer shown with the HSPA adapter 910 and AAA server 920 is the standard by which the HSPA adapter communicates with the AAA server 920. The AAA server program handles user requests for access to computer resources and provides authentication, authorization and accounting services.

Further, the AAA server 920 includes a file transfer protocol (FTP) that is connected to an associated FTP of the charging data record generator (CG)/Billing system 930. Further, the AAA server 920 includes at least a subset of GTP, which is connected to an associated GTP of the CG/Billing system.

One having ordinary skill in the art will readily understand that the invention as discussed above may be practiced with steps in a different order, and/or with hardware elements in configurations which are different than those which are disclosed. For example, the present invention may be implemented at least as a computer product including computer-readable code, a chip set or ASIC, or a processor configured to implement the method or system. Therefore, although the invention has been described based upon these preferred embodiments, it would be apparent to those of skill in the art that certain modifications, variations, and alternative constructions would be apparent, while remaining within the spirit and scope of the invention. In addition, the present invention is related to the 3GPP2. It specifically relates to WLAN Interworking standardization for 3GPP2 packet data networks, and could also be used in 3GPP networks.

1. A system for connecting a high speed packet access (HSPA) user equipment to an Internet node, the system comprises:
a HSPA user equipment;
a base station node for receiving signals from the HSPA user equipment; and
an adapter, integrated in the base station node, wherein the adapter enables the HSPA user equipment to communicate to an Internet node.

2. The system of claim 1, wherein the adapter is integrated via a user-plane (U-plane) of the system.

3. The system of claim 1, wherein the adapter is integrated via a control-plane (C_Plane) system.

4. The system, of claim 1, further including at least one remote adapter, wherein the at least one remote adapter is integrated into an associated remote base station.

5. The system of claim 1, further including an Authentication, Authorization and Accounting (AAA) server, wherein the adapter enables communication between the HSPA user equipment and the AAA server.

6. The system of claim 1, wherein mobility support of the HSPA user equipment is provided.

7. The system of claim 1, further including a mobility entity, wherein the mobility entity that provides system mobility support.

8. A method of enabling a high speed packet access (HSPA) user equipment to communicate with an Internet node, the method comprising:
providing a HSPA user equipment that communicates to an wireless system; integrating an adapter; and
connecting the HSPA user equipment to the Internet node via the adapter.

9. The method of claim 8, wherein integrating the adapter is accomplished by implementing the adapter on the user-plane of the wireless system.

10. The method of claim 8, wherein integrating the adapter is accomplished by implementing the adapter on the control-plane of the wireless system.

11. The method of claim 8, further comprising configuring the adapter to communicate with at least one remote adapter.

12. The method of claim 8, further comprising, configuring the adapter to communicate with a authentication, authorization and billing node.

13. An adapter for enabling a high speed packet access (HSPA) user equipment to communicate with an Internet node, the adapter comprising:
a protocol stack, wherein the protocol stack includes an internet protocol/Media interface protocol (IP/MIP) protocol.

14. The adapter of claim 13, wherein the adapter is integrated into a base station node.

15. The adapter of claim 13, wherein the adapter is implemented in the user-plane of a wireless system.

16. The adapter of claim 13, wherein the adapter is implemented in to control plane of a wireless system.

17. The adapter of claim 13, wherein the adapter enables user authentication, authorization and billing.

18. An apparatus for enabling a HSPA user equipment to access an Internet node in a communications system, the apparatus comprising:
a HSPA user equipment means;
a base station means for receiving signals from the HSPA user equipment means; and
an adapter means, integrated in the base station means, wherein the adapter enables the HSPA user equipment to communicate to an Internet node.

19. The apparatus of claim 18, further including at least one remote adapter means.

20. A computer program embedded on a computer readable medium that cause a computer to perform the steps of claim 8.
